(19) United States
(12) Patent Application Publication
(10) Pub. No.: US 2015/0269304 A1
(43) Pub. Date: Sep. 24, 2015

(54) SYSTEM AND METHOD FOR EMPLOYING SIGNOFF-QUALITY TIMING ANALYSIS INFORMATION CONCURRENTLY IN MULTIPLE SCENARIOS TO REDUCE TOTAL POWER WITHIN A CIRCUIT DESIGN

(71) Applicant: LSI Corporation, San Jose, CA (US)

(72) Inventors: Bruce E. Zahn, Allentown, PA (US); David M. Ratchkov, San Jose, CA (US); Benjamin Mbouombouo, Saratoga, CA (US)

(73) Assignee: LSI Corporation, San Jose, CA (US)

(21) Appl. No.: 14/221,355

(22) Filed: Mar. 21, 2014

(51) Int. Cl. G06F 17/50

(52) U.S. Cl. CPC G06F 17/5081

(57) ABSTRACT

A system is described that analyzes timing of a design and conditionally replaces values of a cell to lower total power within circuit paths having a positive timing margin. The system includes a computing device that includes a memory for storing modules and a processor that is operable to execute the modules. The modules cause the processor to conditionally replace a first semiconductor characteristic with a second semiconductor characteristic associated with a cell in a path of a circuit design and estimating a delay and a slack of the path based upon the first semiconductor characteristic. The modules also cause the processor to determine whether the second semiconductor characteristic causes a timing violation with respect to the path and causes conditional replacement of the second semiconductor characteristic with a third semiconductor characteristic until the timing violation is removed.

### TECHNICAL FIELD

The present disclosure is directed to integrated circuits (ICs) and, more specifically, to a system and method for employing signoff-quality timing analysis information concurrently in multiple scenarios to reduce total power in an electronic circuit, particularly an IC, and an electronic design automation (EDA) tool incorporating the same.

### BACKGROUND

Power consumption is a concern in most circuit designs. Circuit designs should achieve the lowest possible power consumption while achieving defined performance targets. Timing is a major concern in all IC designs, because circuits will not operate properly unless signals can propagate properly through them. Consequently, “timing signoff” is a required step in the designing of a circuit, particularly an IC, and involves using a signoff analysis tool to determine the time that signals will take to propagate through the circuit. If propagation time is inadequate, critical paths in the circuit may have to be modified, or the circuit may have to operate at a slower speed. Power and timing objectives are often at odds; faster devices usually require more power than slower devices, and vice versa.

Electronic design automation (EDA) tools, a category of computer aided design (CAD) tools, are used by electronic circuit designers to create representations of the cells in a particular circuit and the conductors (called “interconnects” or “nets”) that couple the cells together. EDA tools allow designers to construct a circuit design and simulate its performance using a computer and without requiring the costly and lengthy process of fabrication. EDA tools are indispensable for designing modern, very-large-scale integrated circuits (VSLICs). For this reason, EDA tools are in wide use.

### SUMMARY

A system is described that analyzes timing of a design and conditionally replaces values (e.g., channel length values, voltage threshold implant values, cell size values, etc.) associated with a cell to lower total power within circuit paths having a positive timing margin. In one or more embodiments, the system includes a computing device that includes a memory for storing modules and a processor that is operable to execute the modules. The modules cause the processor to conditionally replace a first semiconductor characteristic with a semiconductor characteristic associated with a cell in a path in of a circuit design and estimating a delay and a slack of the path based upon the first semiconductor characteristic. The modules also cause the processor to determine whether the second semiconductor characteristic causes a timing violation with respect to the path and causing conditional replacement of the second semiconductor characteristic with a third semiconductor characteristic until the timing violation is removed.

### BRIEF DESCRIPTION OF THE FIGURES

Reference is now made to the following descriptions taken in conjunction with the accompanying drawings, in which:

FIG. 1 is a block diagram of a total power recovery system in accordance with an example embodiment of the present disclosure.

FIG. 2 is another block diagram of the total power recovery system shown in FIG. 1 in accordance with an example embodiment of the present disclosure.

FIG. 3 is a flow diagram of a power recovery process in accordance with an example embodiment of the present disclosure.

FIG. 4 is a schematic diagram of a portion of an example circuit illustrating operation of the power recovery process shown in FIG. 3.

FIG. 5 is a flow diagram of a speed recovery process in accordance with an example embodiment of the present disclosure.

FIG. 6 is a schematic diagram of a portion of an example circuit illustrating operation of the speed recovery process of FIG. 5.

### WRITTEN DESCRIPTION

Many EDA tool companies offer EDA tools that perform both power and timing optimization. These combined power and timing optimization tools employ approximate circuit models and parameters to represent the circuit design and are used well before timing signoff. Timing signoff then becomes an iterative process of using the signoff analysis tool to analyze timing on an accurate representation of the finished circuit design, reoptimizing for power and timing using the combined optimization tool and reanalyzing using the signoff analysis tool until further optimization becomes unfruitful. Some EDA tool companies offer power optimization tools that run in conjunction with the signoff analysis tool. However, these power optimization tools must be integrated into timing signoff, requiring users to purchase and learn the additional power optimization tool to design a circuit and creating coordination issues between the power optimization tool and the signoff analysis tool which require additional turnaround time to resolve. Such power optimization tools also do not readily adapt to requirements specific to a particular circuit design.

Described herein are various embodiments of an EDA system (e.g., tool) 100 for performing total power recovery in a sign-off environment to achieve favorable power results while preserving timing performance in an electronic circuit, such as an integrated circuit. As described herein, the system 100 analyzes timing of a integrated circuit design and performs cell characteristic modifications (e.g., changes) (e.g., cell swapping) of voltage threshold cells having different channel lengths to lower total power within paths having positive timing margins. For example, the system 100 analyzes the timing of a circuit design and replaces a first cell having a first semiconductor characteristic with a second cell having a second semiconductor characteristic within paths having a positive timing margin. The semiconductor characteristics may comprise, but are not limited to, a cell size value, a voltage threshold implant value, or a channel length value.

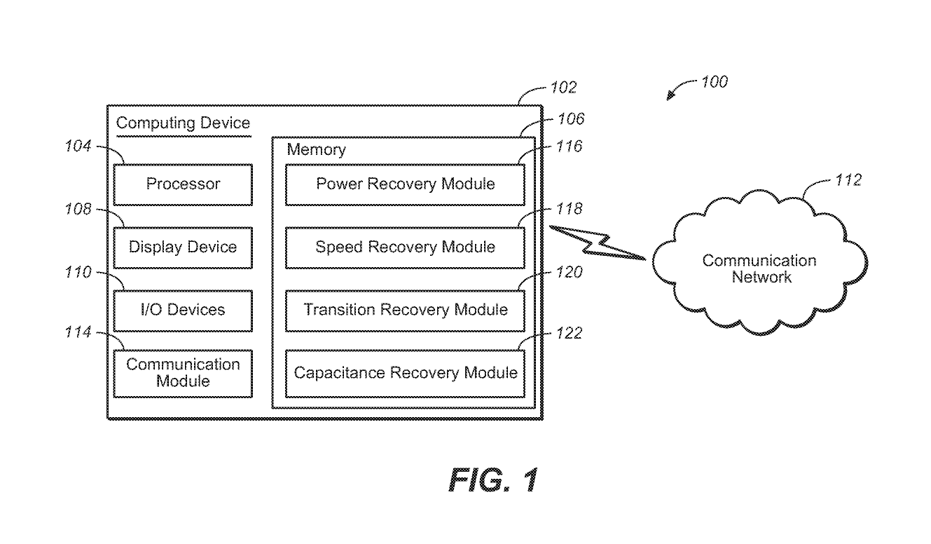

FIG. 1 illustrates an EDA system 100 for employing total power analysis information to improve power results in an electronic circuit with respect to electronic circuits having non-swapped cells or downsized. As shown, the system 100 includes a computing device 102 configured to perform timing signoff analysis. The device 102 is also configured to analyze the timing of a circuit design and perform exchange cells for total power recovery. In one or more implementations, the computing device 102 may be a server computing device, a desktop computing device, a laptop computing device, or the like. As shown in FIG. 1, the computing device 102 includes a processor 104 and a memory 106.

The processor 104 provides processing functionality for the computing device 102 and may include any number of processors, micro-controllers, or other processing systems and resident or external memory for storing data and other information accessed or generated by the computing device 102. The processor 104 may execute one or more software programs (e.g., modules) that implement techniques described herein.

The memory 106 is an example of tangible computer-readable media that provides storage functionality to store various data associated with the operation of the computing device 102, such as the software program and code segments mentioned above, or other data to instruct the processor 104 and other elements of the computing device 102 to perform the steps described herein.

The computing device 102 is also communicatively coupled to a display 108 to display information to a user of the computing device 102. In embodiments, the display 108 may comprise an LCD (Liquid Crystal Diode) display, a TFT (Thin Film Transistor) LCD display, an LEP (Light Emitting Polymer) or PLED (Polymer Light Emitting Diode) display, and so forth, configured to display text and/or graphical information such as a graphical user interface. For example, the display 108 displays visual output to the user. The visual output may include graphics, text, icons, video, interactive fields configured to receive input from a user, and any combination thereof (collectively termed “graphics”).

As shown in FIG. 1, the computing device 102 is also communicatively coupled to one or more input/output (I/O) devices 110 (e.g., a keyboard, buttons, a wireless input device, a thumbwheel input device, a trackstick input device, a touchscreen, and so on). The I/O devices 110 may also include one or more audio I/O devices, such as a microphone, speakers, and so on.

The computing device 102 is configured to communicate with one or more other computing devices over a communication network 112 through a communication module 114. The communication module 114 may be representative of a variety of communication components and functionality, including, but not limited to: one or more antennas; a browser; a transmitter and/or receiver (e.g., radio frequency circuitry); a wireless radio; data ports; software interfaces and drivers; networking interfaces; data processing components; and so forth.

The communication network 112 may comprise a variety of different types of networks and connections that are contemplated, including, but not limited to: the Internet; an intranet; a satellite network; a cellular network; a mobile data network; wired and/or wireless connections; and so forth.

Wireless networks may comprise any of a plurality of communications standards, protocols and technologies, including, but not limited to: Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS), and/or Short Message Service (SMS)), or any other suitable communication protocol.

The illustrated embodiments of the total power recovery system 100 (e.g., the computing device 102) are performed during timing signoff. A signoff analysis tool, such as Primetime-SI® signoff analysis tool (commercially available from Synopsys, Inc., of Mountain View, Calif.), is referenced for purposes of describing the system 100. One or more embodiments of the system 100 are performed ancillary with the Primetime-SI® signoff analysis software. However, those skilled in the pertinent art will recognize that the total power recovery method may be used with or in any conventional or later-developed signoff analysis tool.

Certain embodiments described herein employ the Distributed Multi-Scenario Analysis (DMSA) features available from the Primetime-SI® signoff analysis tool. The DMSA feature allows timing analysis to be completed in a distributed manner in multiple threads or on multiple computers for multiple corners or operating modes. These multiple threads or multiple computers may be regarded as slave processes. Each corner or mode is called a “scenario” and represents an independent Primetime-SI® run at a particular corner or mode. A master process in Primetime-SI® receives information from the slave processes, merging the results of the timing analyses performed thereby. Those skilled in the pertinent art will recognize that other conventional or later-developed signoff analysis tools may have features similar to DMSA; the principles described herein extend to such features.

According to the total power recovery system 100, the timing of a circuit design is analyzed, and cells having a first semiconductor characteristic with a second cell having a second semiconductor characteristic within paths having a positive timing margin (e.g., non-critical paths). The semiconductor characteristic may include, but is not limited to: a channel length characteristic (e.g., a channel length value), a voltage threshold implant characteristic (e.g., voltage threshold implant value), a cell sizing characteristic (e.g., a cell size value). The system 100 performs a modification of the semiconductor characteristic (e.g., voltage threshold modification, cell sizing modification, channel length modification) to lower the total power of cells within a path having a positive timing margin. The system 100 is typically run on a circuit design late in the design process after the design timing is closed, in other words, after the circuit design has been determined to meet its performance goal. Processing multiple scenarios concurrently may result in faster optimization times.

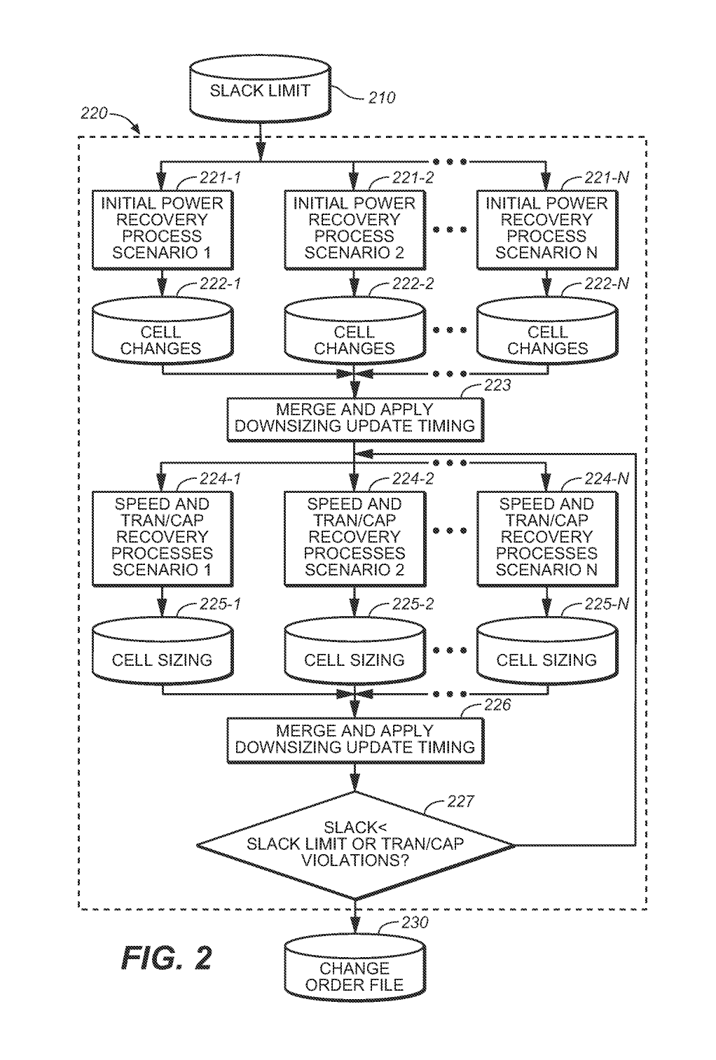

FIG. 2 is a high-level block diagram of one embodiment of a total power recovery system 100 performed according to the present disclosure. The input to the system 100 is one or more slack limit parameters 210, such as a user-defined slack limit. In the embodiment shown in FIG. 2, a timing signoff tool employed by the computing device 102 performs signoff analyses 220 concurrently for each of at least two corners or modes: Scenario 1, Scenario 2, . . . , Scenario N in the illustrated embodiment. A corner represents particular assumptions regarding circuit fabrication or operating voltage or temperature variables.

In the illustrated embodiment, the system 100 includes four recovery modules: a power recovery module 116, a speed recovery module 118, a transition recovery module 120, and/or a capacitance recovery module 122. The modules 116, 118, 120, 122 are stored in the memory 106 and executable by the processor 104. As described herein, the initial power recovery module 116 receives a slack limit value and cell data for the circuit design. The slack limit value may be input by a user or a designer. The cell data may be provided from a cell library and is based upon a design later in the design flow after design timing is complete. The cell data employed meets the performance criteria for the circuit design. The cell library may relate corresponding cells that are functionally the same but have different sizes (e.g., different footprints). For example, the cell library may have an index of such corresponding cells.

The initial power recovery module is configured to identify clock cells and cells that have timing below the slack limit provided and provide these with a non-replacement attribute (e.g., mark as “don't change”). The module 116 executes a loop to determine whether the remaining constrained cells should be changed in order to provide better total power. After determining whether the cells should be changed, the module 116 applies the cell modifications and a timing update is executed. After a timing update occurs, timing failures, transition violations, and capacitance violations are identified.

The speed recovery module 118 is configured to correct timing failures. The module 118 is configured to execute multiple iterations to repair timing issues that are below the user specified limit (e.g., the slack limit). Each iteration loops through the failing timing paths of the circuit design and modifies (e.g., replaces) one or more cells to repair the timing while preserving the total power.

The transition recovery module 120 and the capacitance recovery module 122 are configured to correct the transition and capacitance violations that may have been introduced during the initial power recovery process and/or the speed recovery process. In an embodiment, the modules 120, 122 may be configured to perform transition and capacitance recovery processes performed by the signoff analysis tool. Cells may be replaced on the basis of the transition and capacitance recovery processes. Once the capacitance recovery module 122 performs capacitance recovery, final cell sizes for the circuit design are generated by the device 120.

In one or more embodiments of the present disclosure, the power recovery module 116 represents functionality that executes an instance of an initial power recovery process for each of multiple scenarios (i.e., Scenario 1, Scenario 2, . . . , Scenario N) concurrently, viz., initial power recovery processes 221-1, 221-2, . . . , 221-N. Cells are substituted on the basis of the initial power recovery processes in corresponding instances of cell change processes 222-1, 222-2, . . . , 222-N are carried out concurrently for each of the scenarios. Repeating the initial power recovery processes 221-1, 221-2, . . . , 221-N over multiple scenarios may be particularly advantageous for circuits having multiple modes of operation. The circuit is likely to have a corner (e.g., a slow corner) in each mode that would benefit from a power recovery process carried out according to the present disclosure. The cell changes/replacements/modification are then merged and applied, and a timing update is performed as indicated in a process 223.

Slack is defined as the difference between the time required for a transition to propagate from the start to the end of a particular path and the time required for a transition to propagate from the start to the end of the slowest path that terminates at the same end as the particular path (the “critical path”). A positive slack indicates the degree to which the particular path is faster than the critical path. A negative slack indicates the degree to which the particular path is slower than the critical path. A slack limit is a positive number that a user defines to be any desired value, e.g., 0.20 ns.

In an embodiment, the initial power recovery processes 221-1, 221-2, . . . , 221-N identify one or more clock cells and cells that have timing below the user-defined slack limit provided and marks these as “don't_replace” (e.g., a non-replacement attribute). The remaining constrained cells are then analyzed to determine if those cells could be replaced to achieve better total power (e.g., determining whether replacing the cells would result in a total power that is better with respect to a total power of a circuit having the original cells). The initial power recovery processes 221-1, 221-2, . . . , 221-N estimate delay changes (e.g., slow down or speed up) to avoid timing updates and thereby reduce runtime. After all cells are processed, cell replacements are applied, and a timing update then occurs. After a timing update, timing failures, transition violations, and capacitance may then be determined. Timing failures may result from, for example, timing estimates that are based on limited factors (e.g., in input transition or output load), replaced cells that have different pin capacitance and drive capability and crosstalk effects that may not be accounted for during delay estimation.

The speed, transition, and capacitance recovery modules 118, 120, 122 are respectively configured to furnish functionality configured to carry out an instance of a speed, transition and capacitance recovery process for each of multiple scenarios (e.g., Scenario 1, Scenario 2, . . . , Scenario N) concurrently, viz., speed, transition and capacitance recovery processes 224-1, 224-2, . . . , 224-N. After the power recovery module has carried out the initial power recovery processes 221-1, 221-2, . . . , 221-N, the speed recovery module 118 represents functionality (e.g., a process) that executes (e.g., performs) multiple iterations of the speed recovery processes in each scenario to repair any timing that is below a user-defined slack limit. In an embodiment, each iteration of each instance of the speed recovery process loops through the failing timing paths, replacing the minimum amount of cells to repair the timing while preserving the best total power (e.g., optimal power).

After the speed recovery processes are performed as part of the processes 224-1, 224-2, . . . , 224-N, the transition and capacitance recovery processes are carried out as part of the processes 224-1, 224-2, . . . , 224-N to analyze any transition and capacitance violations that may have been introduced during the initial power recovery processes 221-1, 221-2, . . . , 221-N. In the embodiment of FIG. 2, the transition and capacitance recovery processes are processes performed by a signoff analysis tool. However, those skilled in the pertinent art will understand that later-developed transition and capacitance recovery processes fall within the broad scope of the present disclosure.

In an embodiment, cells are substituted based upon the speed, transition and capacitance recovery processes in corresponding cell swap processes 225-1, 225-2, . . . , 225-N that occur concurrently in each of the scenarios. The cell swaps are then merged and applied, and a timing update is performed as indicated in a process 226. A slack limit and transition and capacitance violation test is applied in a process 227. If the test is failed (signified by the YES branch), the speed, transition and capacitance recovery processes 224-1, 224-2, . . . , 224-N are executed again. If the test is passed, an engineering change order (ECO) file 230 may be generated. The ECO file 230, if implemented, is expected to yield a circuit that exhibits at least some degree of total power optimization while meeting the performance target.

Embodiments of the Power Recovery Process

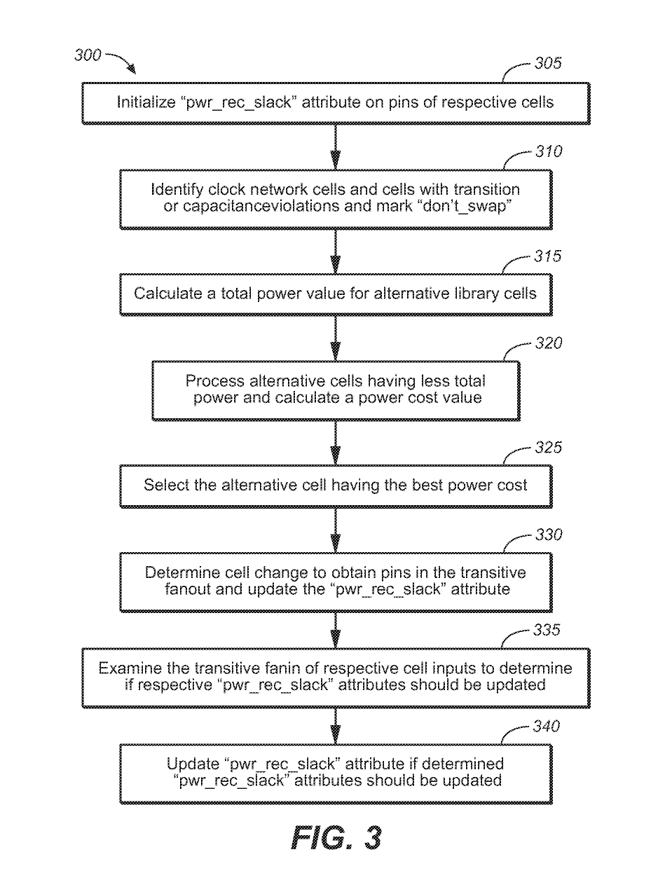

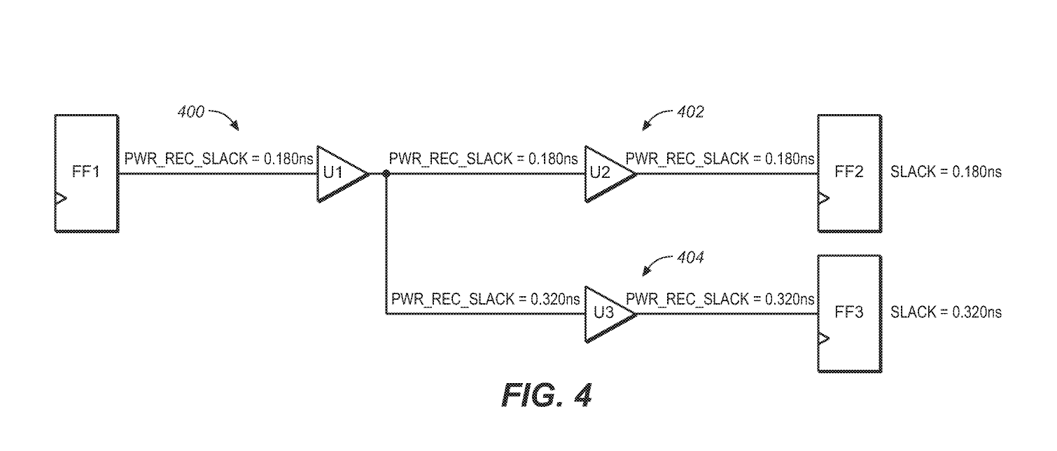

FIG. 3 is a flow diagram of an embodiment of an instance of the initial power recovery process performed by the system 100. Every pin in the in the design is initialized with an attribute called “pwr_rec_slack.” This attribute contains the worst timing slack value (rise or fall) that any timing path through that a pin encounters. For example, FIG. 4 is a schematic diagram of a portion of an example circuit 400 illustrating operation of the power recovery process of FIG. 3. FIG. 4 contains two timing paths 402, 404 that include the output pin “U1/Z.” One path starts at FF1 and ends at FF2 with a timing slack of 0.180 ns, and another path starts at FF1 and ends at FF3 with a timing slack of 0.320 ns. Since the worst timing slack through the output pin “U1/Z” is 0.180 ns, its pwr_rec_slack attribute is set to 0.180 ns. The output pin “U3/Z” has a worst timing slack set to 0.320 ns.

After the design is initialized with the “pwr_rec_slack” attributes (Step 305), clock network cells and cells with transition or capacitance violations (e.g., those that have an initial starting timing slack below the user-defined slack limit or cells that are unconstrained). A cell that is unconstrained does not contain a timing slack value since it is constrained in another mode of analysis. Every such cell is marked “don't_replace” (e.g., associate a non-replacement attribute with respective cell) (Step 310); and cells not marked “don't_replace” are then processed. The system 100 identifies a cell type parameter, an input transition ramp time parameter, and an output load capacitance parameter. Using these parameters, the system 100 calculates a total power value for alternative library cells (Step 315). The power recovery module 116 then processes the alternative cells having less total power and calculates a power cost value (Step 320). The power cost value takes into account many parameters, such as delay slow down and total power reduction of the cell. This may enable the smallest amount to timing slow down affect for the largest amount of power gain. By using the total power value for each cell, the system 100 can determine when it is beneficial to trade off leakage power for dynamic power to achieve the best total power.

For example, for an alternative cell BUFX3BV0L9020D has a drive strength of “X3” and a low voltage threshold with 20 channel length. The choices of different voltage threshold/channel lengths are, U9016D, U9020D, L9016D, L9020D, S9016D, and S9020D. The U, L, and S stand for the voltage threshold (ultra-low, low and standard) and the 9016D or 9020D identify the channel length (16 nm or 20 nm). The order specified above is from most leakage/fastest delay to least leakage/slowest delay. Thus, a U9016D cell is faster than a U9020D cell but results in more leakage power. Likewise the U9020D cell is faster than the L9016D cell but will have more leakage power.

The choices of smaller cells to reduce dynamic power are cells smaller than the “X3” size such as “X2,” “X1P5,” “X0P8,” and “X0P5.” Thus, for dynamic power, the best choice (lowest area/drive cell) is a “0.5” cell. However, the alternate cell chosen must have a speed attribute to pass timing and have the lowest total power. The system 100 examines all the alternative cells and removes any with worse total power than the original. The system 100 then removes alternative cells that would cause a timing failure. The remaining alternative cells are then sorted by the best power cost. For example, the remaining alternative cells are shown in Table 1 illustrating area, cell type, starting slack, estimated slack, delay slow down, drive size, total power, and power cost:

TABLE 1

| | | Orig. | Estimated | | Total | Ratio Delay |
|---|---|---|---|---|---|---|
| Area | Cell Type | Slack | Slack | Slack Diff. | Power | Over Power |
| 0.20736 | BUFX0P5BV0U9016D | 0.113832 | 0.024 | 0.089832 | 0.002552 | 233.0942323 |
| 0.20736 | BUFX0P5BV0U9020D | 0.113832 | 0.004973 | 0.108859 | 0.002548 | 282.6870277 |
| 0.20736 | BUFX0P8BV0L9016D | 0.113832 | 0.030426 | 0.083406 | 0.001885 | 228.057945 |
| 0.20736 | BUFX0P8BV0L9020D | 0.113832 | 0.009578 | 0.104254 | 0.001891 | 289.6224547 |
| 0.20736 | BUFX0P8BV0U9020D | 0.113832 | 0.067525 | 0.046307 | 0.001917 | 138.705873 |
| 0.20736 | BUFX0P8BV0U9016D | 0.113832 | 0.079835 | 0.033997 | 0.00192 | 102.7165123 |
| 0.20736 | BUFX1BV0L9016D | 0.113832 | 0.059624 | 0.054208 | 0.00193 | 168.7900488 |
| 0.20736 | BUFX1BV0L9020D | 0.113832 | 0.042015 | 0.071817 | 0.00193 | 229.7684186 |
| 0.2592 | BUFX1P5BV0S9016D | 0.113832 | 0.047377 | 0.066455 | 0.001945 | 217.0693471 |
| 0.2592 | BUFX1P5BV0L9016D | 0.113832 | 0.093891 | 0.019941 | 0.001952 | 66.76892491 |
| 0.2592 | BUFX1P5BV0S9020D | 0.113832 | 0.22538 | 0.091294 | 0.00196 | 313.4358311 |
| 0.2592 | BUFX1P5BV0L9020D | 0.113832 | 0.080371 | 0.033461 | 0.001961 | 115.4249052 |
| 0.20736 | BUFX1BV0U9020D | 0.113832 | 0.092986 | 0.020846 | 0.00197 | 74.18686408 |
| 0.20736 | BUFX1BV0U9016D | 0.113832 | 0.102273 | 0.011559 | 0.001971 | 41.29705484 |
| 0.2592 | BUFX2BV0S9016D | 0.113832 | 0.068687 | 0.45145 | 0.002007 | 185.5182978 |
| 0.2592 | BUFX2BV0L9016D | 0.113832 | 0.108156 | 0.005676 | 0.00201 | 24.06354725 |
| 0.2592 | BUFX2BV0S9020D | 0.113832 | 0.048204 | 0.065631 | 0.002027 | 293.7328952 |
| 0.2592 | BUFX2BV0L9020D | 0.113832 | 0.096565 | 0.017267 | 0.00203 | 78.25059156 |
| 0.36288 | BUFX3BV0S9016D | 0.113832 | 0.092326 | 0.021506 | 0.00221 | 532.2154434 |
| 0.36288 | BUFX3BV0S9020D | 0.113832 | 0.113832 | 0 | 0.002251 | 0 |

It can be seen from this information that even though the smallest drive strength is “X0P5,” which may pass timing if the ultra-low voltage threshold cell is used, this cell may be excluded because the leakage is so high that the overall total power would be worse (as compared to the original cell). The power recovery module 116 is configured to select the cell with the best power cost (Step 325), which, in this embodiment, is the “BUFX0P8V0L9016D” cell. For example, the first two entries in Table 1 have a higher total power than the original selection. The leakage of this cell is worse than the starting cell (“S9020D”), but the dynamic gain characteristic is such that the total power is less. The cell selected may have the best overall total power cost. The power cost comprises various components, such as absolute total power, ratio of delay change over total power change, and fanin/fanout factor of the cell. The fanin/fanout factor refers to how much logic the cell affects in the circuit. Cells involved in large amounts of circuit may impact more timing then cells involved in small portion of the logic. The cost function wants to get the largest gain in total power for the smallest delay slowdown, affecting the smallest amount of other logic.

After all cells with timing margin are processed, the power recovery module 116 processes the cells by power cost, and for each cell, determines the cell change to obtain the pins in the transitive fanout and updates the “pwr_rec_slack” attribute to reflect this slow down (Step 330). Next the transitive fanin to each of the cell's input pins are examined to determine if the respective “pwr_rec_slack” attributes should be updated (Step 335). Each “pwr_rec_slack” attribute of the pins in the transitive fanin is updated if its value is at least substantially equal to the original cell's “pwr_rec_slack” attribute (Step 340). In an embodiment, the pins with a “pwr_rec_slack” attribute equal to the current cell's input pin “pwr_rec_slack” attribute are modified to ensure those fanin pins are within the worst path. If a fanin pin does not have the same “pwr_rec_slack” value, it is involved in a different worst path and is not modified.

The result of the power recovery phase is a list of cell changes that are implemented. The timing of the design is then updated. This update will cause timing violations, transition violations and capacitance violations. At this stage multiple iterations of speed recovery are performed to repair any timing that is below the user specified limit.

Embodiments of the Speed Recovery Process

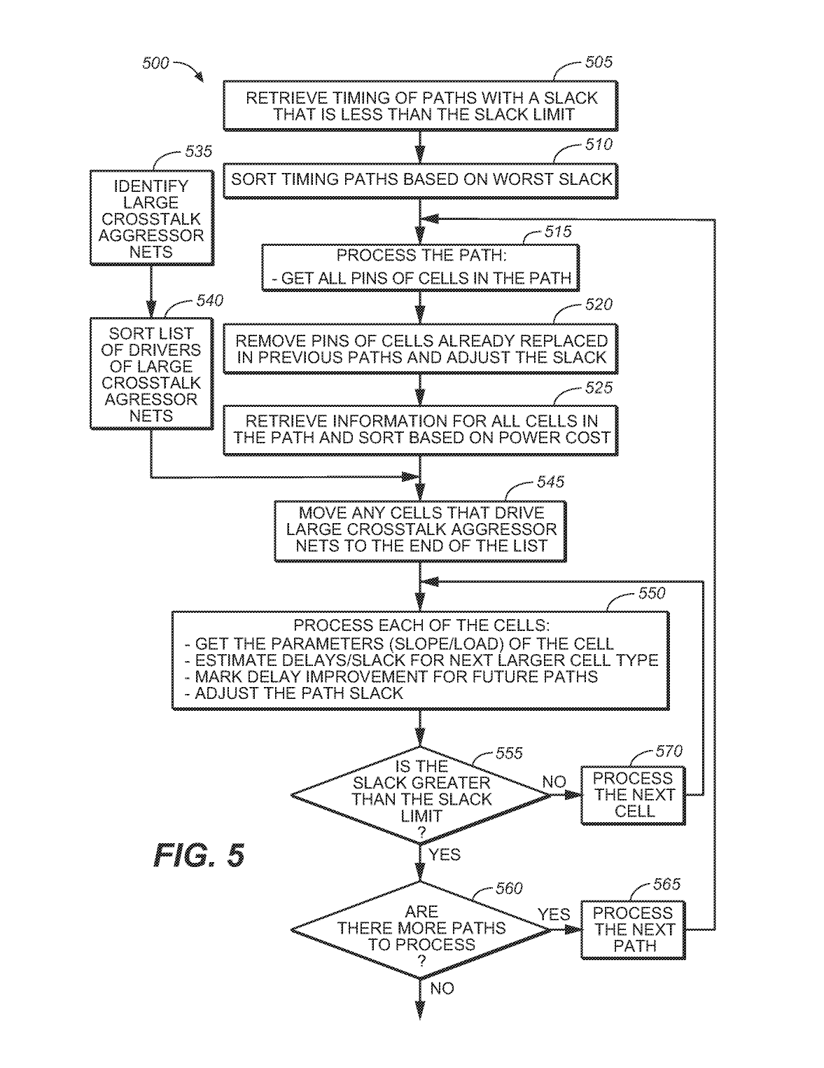

FIG. 5 is a flow diagram of an embodiment of an instance of a speed recovery process performed by the system 100 shown in FIG. 1. The illustrated embodiment of the speed recovery process analyzes failing paths to perform cell replacements to repair the timing of the design while preserving the best overall total power (e.g., a total power that is better than a total power of a circuit design having a replaced cell). The speed recovery process retrieves the timing of failing paths (Step 505) to sort the failing paths for each clock group by worst (least) timing slack (Step 510). For each path, the pins of the cells in the path are retrieved (Step 515). Pins of cells already replaced by the speed recovery process (due to their being in previously processed paths) are removed (Step 520), and the slack is adjusted accordingly. A loop is undertaken for each cell type having a semiconductor characteristic in the path (Step 525). For example, the semiconductor characteristic may comprise a channel length characteristic, a voltage threshold characteristic, or a cell sizing characteristic. Information regarding all cells in the path of a given celltype are retrieved (Step 530) and sorted into a list based on delay. In the illustrated embodiment, the cells are sorted by descending delay.

The illustrated embodiment of the speed recovery process takes into consideration cells that are crosstalk aggressors of crosstalk victim nets. The cells that drive crosstalk aggressor nets (those having crosstalk exceeding a threshold) are handled differently to minimize the introduction of additional crosstalk delay variation on victim nets, which can degrade timing. Those skilled in the art are aware of how to calculate the degree to which nets are responsible for crosstalk with adjacent nets.

Referring to FIG. 5, before processing the failing paths of the circuit design, an analysis to identify the largest crosstalk aggressor nets of victim nets involved in failing timing paths is completed (Step 535). Large crosstalk aggressor nets are then sorted (Step 540). The cells that drive the large aggressor nets are moved to the bottom of the sorted list (Step 545). In an embodiment, crosstalk aggression is used as a cost factor when processing paths to determine the best candidates to replace cells having lower total power attributes and discourages the replacement of a cell that is an aggressor to many victim nets.

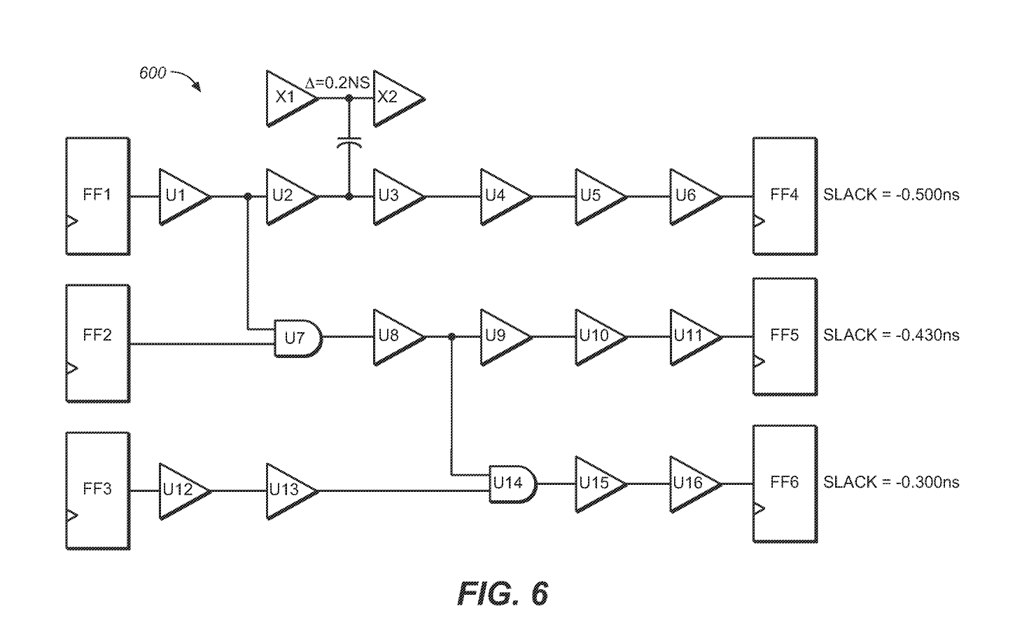

In the example circuit 600 shown in FIG. 6, the worst timing path is from FF1=>FF4 with a timing slack of −0.500 ns. The next worst path is from FF1=>FF5 with a timing slack of −0.430 ns and so on. Certain endpoint flip-flop devices, such as FF5 and FF6, have multiple timing paths from different starting points. For example FF5 has two timing paths, one from FF1 and one from FF2. The module 118 loops on failing timing paths and sorts the failing paths by the worst timing slack. When processing the worst timing path, the module 118 loops through each cell. Thus, when processing the FF1=>FF4 path, the cells are sorted based upon total power cost. Any cells that have been identified earlier as being involved as crosstalk aggressors are put to the bottom of the sorted list. For example, instance “U2” is an aggressor to the net driven by instance “X1” and is considered last for cell changes (e.g., upsizing, voltage threshold implant swap, channel length modification) to avoid increasing the aggression. Each of these cells is then processed by the system 100 to obtain respective input transition and output load. Based on these parameters, an estimated delay is obtained for the next larger size of this cell type. The timing slack is then adjusted by the delay improvement of this cell change. Additional cells are processed unless the timing slack becomes greater that the slack limit. This may allow the minimum number of cell change to meet the timing performance target.

The delay improvement estimate is stored on the output pin of the cell scheduled to be replaced. This is done so that if this cell is involved in other timing paths the slack can be adjusted before any new cells in the timing path are processed. For example, while processing path FF1=>FF4, instance “U1” is marked to be replaced and this result is a 0.050 ns faster delay on U1. This delay is stored on the “U1” output pin. When the FF1=>FF5 path is processed, the module 118 determines if any cells have been modified from a previous path and adjusts the slack by the delay improvement. In this case the slack value would be adjusted by the 0.050 ns improvement from U1. When the cells in a path are being processed, a cell may be modified if the cell was changed previously during the initial power recovery stage. This is to ensure that hold violations are not introduced. In addition, cells may never be made larger than a cells original area.

Referring to FIG. 5, the cells are processed (Step 550). The processing of the cells may include: obtaining various parameters (e.g., slope/load) of the cell, estimate a delay/slack for another cell type (e.g., a cell type having a different channel length characteristic, a cell type having a different voltage threshold implant characteristic, a cell type having a different cell size characteristic), determining whether delay improvements for future paths, and/or adjust a path slack attribute. The module 118 determines whether the slack is greater than the slack limit (Decision Step 555). If the slack is greater (Yes from Decision Step 555), the module 118 determines whether additional paths are to be processed (Decision Step 560). If there are additional paths to process, the next path is processed (Step 465). If there are no additional paths to process, method 500 is complete. If the slack is not greater (No from Decision Step 555), the next cell is processed (Step 570).

In the illustrated embodiment, multiple iterations of the speed recovery routine are run to repair the entire timing of the circuit design. To reduce runtime, the number of failing paths processed may be chosen carefully. Processing all failing paths may consume too much runtime and lead to diminishing improvement if many of the cells in the failing paths have been processed earlier. This can also be design-specific as some designs may have deep combinational logic (such as multiplexing) to specific endpoints.

The speed recovery process monitors the timing improvement for each iteration. If the timing improvement is not making substantial progress, another speed recovery approach is adopted. This approach focuses on cells rather than paths. After the cell timing improvement is estimated, it is propagated to cells in the transistive fanin/fanout in a similar manner to the cell in the power recovery phase. After all the speed recovery process iterations are complete, the timing should be repaired to the user-defined slack limit.

Transition and Capacitance Recovery

After the speed recovery portion is completed the speed recovery process identifies any transition and capacitance violations that were introduced by cell replacement performed during the power recovery process. The driver cells on transition violations are replaced with cells that have sharper transition times. Similarly cells with maximum capacitance violations are changed back to cells that can drive a larger load.

Generally, any of the functions described herein can be implemented using hardware (e.g., fixed logic circuitry such as integrated circuits), software, firmware, manual processing, or a combination of these embodiments. Thus, the blocks discussed in the above disclosure generally represent hardware (e.g., fixed logic circuitry such as integrated circuits), software, firmware, or a combination thereof. In the instance of a hardware embodiment, for instance, the various blocks discussed in the above disclosure may be implemented as integrated circuits along with other functionality. Such integrated circuits may include all of the functions of a given block, system or circuit, or a portion of the functions of the block, system or circuit. Further, elements of the blocks, systems or circuits may be implemented across multiple integrated circuits. Such integrated circuits may comprise various integrated circuits including, but not necessarily limited to: a monolithic integrated circuit, a flip chip integrated circuit, a multichip module integrated circuit, and/or a mixed signal integrated circuit. In the instance of a software embodiment, for instance, the various blocks discussed in the above disclosure represent executable instructions (e.g., program code) that perform specified tasks when executed on a processor. These executable instructions can be stored in one or more tangible computer readable media. In some such instances, the entire system, block or circuit may be implemented using its software or firmware equivalent. In other instances, one part of a given system, block or circuit may be implemented in software or firmware, while other parts are implemented in hardware.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a computing device, the computing device comprising:
a memory operable to store one or more modules;
a processor coupled to the memory, the processor operable to execute the one or more modules to:
cause the processor to conditionally replace a first semiconductor characteristic with a second semiconductor characteristic associated with at least one cell in at least one path in a circuit design and estimating a delay and a slack of the at least one path based upon the first characteristic semiconductor characteristic; and
cause the processor to determine whether the second semiconductor characteristic causes a timing violation with respect to the at least one path and causing conditional replacement of the second semiconductor characteristic with a third semiconductor characteristic until the timing violation is removed.

2. The apparatus as recited in claim 1, wherein first semiconductor characteristic comprises at least one of a first channel length characteristic, a first voltage threshold implant, or a first cell size characteristic, the second semiconductor characteristic comprises at least one of a second channel length characteristic, a second voltage threshold implant, or a second cell size characteristic, and the third semiconductor characteristic comprises at least one of a third channel length characteristic, a third voltage threshold implant, or a third cell size characteristic.

3. The apparatus as recited in claim 1, wherein the at least one cell having the second semiconductor characteristic has an equivalent footprint area as the at least one cell having the first characteristic semiconductor characteristic.

4. The apparatus as recited in claim 1, wherein the processor is further operable to execute the one or more modules to exempt clock network cells and cells having transition or capacitance violations from the conditional replacement.

5. The apparatus as recited in claim 1, wherein the processor is further operable to execute the one or more modules to conditionally replace the second semiconductor characteristic with a third semiconductor characteristic with respect to a minimum number of cells to remove the timing violation.

6. The apparatus as recited in claim 1, wherein the at least one cell having the second semiconductor characteristic has a smaller footprint area as the at least one cell having the first characteristic semiconductor characteristic.

7. The apparatus as recited in claim 1, wherein the processor is further operable to execute the iteratively replace the second semiconductor characteristic with a third semiconductor characteristic to remove the timing violation.

8. A method comprising:
conditionally replacing a first semiconductor characteristic with a second semiconductor characteristic associated with at least one cell in at least one path in a circuit design;
estimating a delay and a slack of the at least one path based on the conditional replacement;
determining whether the conditional replacement causes a timing violation with respect to the at least one path; and
conditionally replacing the second semiconductor characteristic associated with the at least one cell with a third semiconductor characteristic until the timing violation is removed.

9. The method as recited in claim 8, wherein first semiconductor characteristic comprises at least one of a first channel length characteristic, a first voltage threshold implant, or a first cell size characteristic, the second semiconductor characteristic comprises at least one of a second channel length characteristic, a second voltage threshold implant, or a second cell size characteristic, and the third semiconductor characteristic comprises at least one of a third channel length characteristic, a third voltage threshold implant, or a third cell size characteristic.

10. The method as recited in claim 8, wherein the at least one cell having the second semiconductor characteristic has an equivalent footprint area as the at least one cell having the first semiconductor characteristic.

11. The method as recited in claim 8, further comprising exempting clock network cells and cells having transition or capacitance violations from the conditional replacement.

12. The method as recited in claim 8, conditionally replacing the second semiconductor characteristic with a third semiconductor characteristic with respect to a minimum number of cells to remove the timing violation.

13. The method as recited in claim 8, wherein the at least one cell having the second semiconductor characteristic has a smaller footprint area as the at least one cell having the first characteristic semiconductor characteristic.

14. The method as recited in claim 8, further comprising iteratively replace the second semiconductor characteristic with a third semiconductor characteristic to remove the timing violation.

15. An apparatus comprising:
a computing device, the computing device comprising:
a memory operable to store one or more modules;
a processor coupled to the memory, the processor operable to execute the one or more modules to:
receive an input file, the input file including data representing a circuit design, the circuit design including at least one cell;
cause the processor to conditionally replace a first semiconductor characteristic with a second semiconductor characteristic associated with the at least one cell in at least one path in the circuit design and estimating a delay and a slack of the at least one path based upon the first semiconductor characteristic; and
cause the processor to determine whether the second semiconductor characteristic causes a timing violation with respect to the at least one path and causing conditional replacement of the second semiconductor characteristic with a third semiconductor characteristic until the timing violation is removed.

16. The apparatus as recited in claim 15, wherein first semiconductor characteristic comprises at least one of a first channel length characteristic, a first voltage threshold implant, or a first cell size characteristic, the second semiconductor characteristic comprises at least one of a second channel length characteristic, a second voltage threshold implant, or a second cell size characteristic, and the third semiconductor characteristic comprises at least one of a third channel length characteristic, a third voltage threshold implant, or a third cell size characteristic.

17. The apparatus as recited in claim 15, wherein the at least one cell having the second semiconductor characteristic has an equivalent footprint area as the at least one cell having the first semiconductor characteristic.

18. The apparatus as recited in claim 15, wherein the processor is further operable to execute the one or more modules to exempt clock network cells and cells having transition or capacitance violations from the conditional replacement.

19. The apparatus as recited in claim 15, wherein the processor is further operable to execute the one or more modules to conditionally replace the second semiconductor characteristic with a third semiconductor characteristic with respect to a minimum number of cells to remove the timing violation.

20. The apparatus as recited in claim 15, wherein the at least one cell having the second semiconductor characteristic has an equivalent footprint area as the at least one cell having the first semiconductor characteristic.
